(19) United States
(12) Patent Application Publication
(10) Pub. No.: US 2022/0372243 A1
(43) Pub. Date: Nov. 24, 2022

(54) ANTIMICROBIAL COMPOSITION HAVING EXCELLENT ANTIMICROBIAL PROPERTY AND IMPROVED CHEMICAL RESISTANCE, AND MOLDED ARTICLE INCLUDING SAME

(71) Applicants: Hyundai Motor Company, Seoul (KR); Kia Corporation, Seoul (KR)

(72) Inventors: Jin Gi Ahn, Seoul (KR); Kyeong Hoon Jang, Seoul (KR); Dae Sik Kim, Yongin (KR); Jung Kyu Han, Sejong (KR); Do Young Bae, Daejoen (KR); Jong Ung Byeon, Daejeon (KR); Tae Jin An, Daejeon (KR); Su Hyuk Jang, Daejeon (KR); Chul Jin Jo, Daejeon (KR)

(21) Appl. No.: 17/532,906

(22) Filed: Nov. 22, 2021

(30) Foreign Application Priority Data
May 11, 2021 (KR) 10-2021-0060922

(51) Int. Cl. C08K 3/08; C08K 7/16; C08L 69/00; C08K 9/02; C08K 9/12

(52) U.S. Cl. CPC C08K 3/08; C08K 7/16; C08L 69/00; C08K 9/02; C08K 9/12; C08L 67/02

(57) ABSTRACT

Disclosed are an antimicrobial composition having excellent antimicrobial and anti-fungal properties and improved fingerprint resistance and chemical resistance, and a molded article including the same. The antimicrobial composition includes a combination of an amount of about 45 to 85 wt % of a polycarbonate resin, an amount of about 10 to 36 wt % of a polyester resin, an amount of about 3 to 12 wt % of an impact modifier, an amount of about 0.2 to 2 wt % of an inorganic antimicrobial agent, and an amount of about 1 to 6 wt % of a micro powder including a fluorine-based polymer resin, based on the total weight of the antimicrobial composition.

### CROSS REFERENCE TO RELATED APPLICATION

The present application claims priority to Korean Patent Application No. 10-2021-0060922, filed May 11, 2021, the entire contents of which is incorporated herein for all purposes by this reference.

### TECHNICAL FIELD

The present invention relates to an antimicrobial composition having excellent antimicrobial and anti-fungal properties and improved fingerprint resistance and chemical resistance, and to a molded article including the same.

### BACKGROUND

Polycarbonate resins are excellent in impact resistance, heat resistance, and mechanical strength, and have good processability, and are therefore widely used in automobile parts, housings of electrical and electronic products, and housings of portable electronic devices.

Recently, much research has been conducted to develop unpainted products without post-processing in order to reduce manufacturing costs and protect the environment in automobile interior and exterior materials and various electric and electronic fields. Various electronic products such as mobile phones, notebook computers, tablet PCs, and kiosks, or medical supplies, bus handles, and automobile interior and exterior parts that frequently come into contact with the human body are in contact with the human body such as the user's hands or face with frequency, so foreign materials such as moisture, hand stains, oil, and cosmetics are attached to the product, or marks such as fingerprints remain thereon. Attachment of foreign materials or marks such as fingerprints may make the surface of the product dirty, and various pathogens such as Escherichia coli and staphylococcus, which are harmful to the human body, may break out and multiply in the foreign materials, which may cause various diseases.

Recently, as a concern in hygiene is increasing, many efforts have been made to develop products with antimicrobial properties for the plastic material. The antimicrobial properties of plastics may greatly depend on the type and content of an antimicrobial agent and on whether or not post-processing such as painting is performed. For example, the application of an unpainted material is essential in order to increase the antimicrobial properties. However, in order to maintain the good appearance quality of unpainted products, fingerprint resistance and chemical resistance must be supported.

Therefore, it is necessary to develop an antimicrobial composition having excellent antimicrobial and anti-fungal properties and good fingerprint resistance and chemical resistance.

In the related art, a method of using a combination of Ag and Zn antimicrobial agents has been used to prevent degradation of compatibility of an antimicrobial agent with a polycarbonate resin and transparency and physical properties thereof. Moreover, a method of combining diene-based and acryl-based composite rubber-based graft copolymers has been used to secure antimicrobial properties, weather resistance, and flame retardancy. Further, a method of administering an antimicrobial agent during a polymerization process of resins has been reported. However, the above technologies are limited to the securing of antimicrobial activity, transparency, weather resistance, and flame retardancy, so there is a problem in that fingerprint resistance and chemical resistance required for non-painting, which are essential for the expression of antimicrobial properties, are not secured. In addition, there is a problem in that heat resistance is deteriorated due to the application of the antimicrobial agent.

Also, in the related art, a fluorine-based coating method has been used to secure antimicrobial activity and fingerprint resistance. However, the above technology requires an additional coating process, resulting in an increase in product manufacturing cost and the occurrence of defective products, and an organic antimicrobial agent is applied thereto, so the antimicrobial persistence is inferior. Further, when a coating layer is worn or peeled off, antimicrobial properties and fingerprint resistance are lost.

In addition, a method where fingerprint resistance is improved through fluorine-based coating has been reported, but there are problems in that the antimicrobial property is not secured and a coating process is required to secure fingerprint resistance.

### SUMMARY

In preferred aspects, provided is an antimicrobial composition having excellent antimicrobial and anti-fungal properties and improved fingerprint resistance and chemical resistance.

In an aspect, provided is an antimicrobial composition may include a polycarbonate resin, a polyester resin, an inorganic antimicrobial agent, an impact modifier, and a micro powder including a fluorine-based polymer resin.

In certain preferred antimicrobial compositions, each of a polycarbonate resin; a polyester resin; an inorganic antimicrobial agent; an impact modifier; and a micro powder including a fluorine-based polymer resin is a separate (e.g., not covalently liked) component of the composition.

The term “micro powder” as used herein refers to a powder or particular substance having regular or irregular and globular or spherical shape and having a size (e.g., average particle diameter) in a range of 1 nm to 1000 μm, range of 10 nm to 500 μm, or 10 nm to 300 μm.

The antimicrobial composition may suitably include an amount of about 45 to 85 wt % of the polycarbonate resin, an amount of about 10 to 36 wt % of the polyester resin, an amount of about 0.2 to 2 wt % of the inorganic antimicrobial agent, an amount of about 3 to 12 wt % of the impact modifier, and an amount of about 1 to 6 wt % of the micro powder, based on the total weight of the antimicrobial composition.

The polycarbonate resin may include an aromatic polycarbonate resin.

The polycarbonate resin may have a viscosity average molecular weight (Mv) of about 15,000 to 40,000 measured in a methylene chloride solution at a temperature of about 25° C.

The polyester resin may include one or more selected from the group consisting of a polyethylene terephthalate resin, a polytrimethylene terephthalate resin, a polybutylene terephthalate resin, a polyhexamethylene terephthalate resin, a polycyclohexane dimethylene terephthalate resin, and an amorphous modified substance thereof.

The polyester resin may have an intrinsic viscosity [η] of about 0.85 to 1.52 dl/g.

The inorganic antimicrobial agent may include one or more antimicrobial materials selected from the group consisting of silver (Ag), zinc (Zn), copper (Cu), tin (Sn), platinum (Pt), barium (Ba), magnesium (Mg), germanium (Ge), and calcium (Ca), and a support containing the antimicrobial material.

The support may include one or more selected from the group consisting of glass, zeolite, and zirconia.

The impact modifier may include a core containing a rubbery polymer, and a shell containing a vinyl monomer graft-copolymerized to the core.

The micro powder may include one or more fluorine-based polymer resin selected from the group consisting of polytetrafluoroethylene, a tetrafluoroethylene-perfluoroalkylvinyl ether copolymer, a tetrafluoroethylene-hexafluoropropylene copolymer, an ethylene-tetrafluoroethylene copolymer resin, a tetrafluoroethylene-chlorotrifluoroethylene copolymer, and an ethylene-chlorotrifluoroethylene resin.

The micro powder may form a sphere.

The micro powder may have an average particle diameter (D50) of about 0.01 to 300 μm.

The micro powder may have a weight average molecular weight (Mw) of about 10,000 to 500,000.

According to the present invention, it is possible to obtain an antimicrobial composition having excellent antimicrobial and anti-fungal properties and a molded article including the same.

According to the present invention, even when a small amount of antimicrobial agents is used, it is possible to obtain an antimicrobial composition having excellent antimicrobial and anti-fungal properties and a molded article including the same.

According to the present invention, it is possible to obtain an antimicrobial composition having excellent heat resistance, impact resistance, fingerprint resistance, and chemical resistance compared to conventional antimicrobial materials, and a molded article including the same.

The effects of the present invention are not limited to the above-mentioned effects. It should be understood that the effects of the present invention include all effects that can be inferred from the following description.

### DETAILED DESCRIPTION

The above objectives, other objectives, features, and advantages of the present invention will be easily understood through the following preferred embodiments related to the accompanying drawings. However, the present invention is not limited to the embodiments described herein and may be embodied in other forms. Rather, the embodiments introduced herein are provided so that the disclosed content may be thorough and complete, and the spirit of the present invention may be sufficiently conveyed to those skilled in the art.

In describing each drawing, similar reference numerals have been used for similar elements. In the accompanying drawings, the dimensions of the structures are shown to be enlarged than they actually are for the purpose of clarity of the present invention. Terms such as first and second may be used to describe various elements, but the elements should not be limited by the terms. The above terms are used only for the purpose of distinguishing one element from another element. For example, without departing from the scope of the present invention, a first element may be referred to as a second element, and similarly, a second element may be referred to as a first element. Singular expressions include plural expressions unless the context clearly indicates otherwise.

In the present specification, it is to be understood that terms such as “include” or “have” are intended to designate the presence of features, numbers, steps, actions, elements, parts, or combinations thereof described in the specification, but do not preclude the possibility of the presence or addition of one or more other features, numbers, steps, actions, elements, parts, or combinations thereof. Further, when a part such as a layer, a film, a region, and a plate is said to be “on” another part, this includes cases where one part is “directly on” the other part, as well as cases where there is another part therebetween. Conversely, when a part such as a layer, a film, a region, and a plate is said to be “under” another part, this includes cases where one part is “directly under” the other part, as well as cases where there is another part therebetween.

Unless otherwise specified, all numbers, values, and/or expressions expressing ingredients, reaction conditions, polymer compositions, and quantities of formulations used in the present specification are approximations that reflect the various uncertainties in the measurement inherently occurring in obtaining these values among others. Accordingly, it should be understood as being modified in all cases by the term “about” as such numbers are inherently approximations that are reflective of, among other things, the various uncertainties of measurement encountered in obtaining such values.

Further, when numerical ranges are disclosed herein, such ranges are continuous and, unless otherwise indicated, include all values from the minimum to the maximum values within the ranges. Moreover, when such ranges refer to an integer, all integers including the minimum to the maximum values are included therein, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

An antimicrobial composition may include (a) a polycarbonate resin, (b) a polyester resin, (c) an inorganic antimicrobial agent, (d) an impact modifier, and (e) a fluorine-based polymer resin.

Hereinafter, each component will be described in detail.

(a) Polycarbonate Resin

The polycarbonate resin may include an aromatic polycarbonate resin.

The polycarbonate resin may be manufactured from dihydric phenol, a carbonate precursor, and a molecular weight modifier.

The dihydric phenols may include a monomer represented by the following Chemical Formula 1.

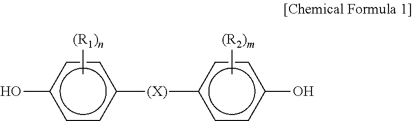

In Chemical Formula 1, X represents an alkylene group; a straight, branched, or cyclic alkylene group having no functional group; or a straight, branched, or cyclic alkylene group containing a functional group such as sulfide, ether, sulfoxide, sulfone, ketone, naphthyl, and isobutylphenyl, and preferably x may be a straight or branched alkylene group having 1 to 10 carbon atoms or a cyclic alkylene group having 3 to 6 carbon atoms. R₁ and R₂ may each independently be a hydrogen atom, a halogen atom, or an alkyl group, for example, a straight or branched alkyl group having 1 to 20 carbon atoms or a cyclic alkyl group having 3 to 20 (preferably 3 to 6) carbon atoms. n and m are independently an integer of 0 to 4.

Non-limiting examples of the dihydric phenols include bis(4-hydroxyphenyl)methane, bis(4-hydroxyphenyl)phenylmethane, bis(4-hydroxyphenyl)naphthylmethane, bis(4-hydroxyphenyl)-(4-isobutylphenyl)methane,1,1-bis(4-hydroxyphenyl)ethane, 1-ethyl-1,1-bis(4-hydroxyphenyl)propane, 1-phenyl-1,1-bis(4-hydroxyphenyl)ethane,1-naphthyl-1,1-bis(4-hydroxyphenyl)ethane, 1,2-bis(4-hydroxyphenyl)ethane,1,10-bis(4-hydroxyphenyl)decane, 2-methyl-1,1-bis(4-hydroxyphenyl)propane, and 2,2-bis(4-hydroxyphenyl)propane (bisphenol A). Preferably, the dihydric phenol may include bisphenol A.

The carbonate precursor may include phosgene(carbonyl chloride). However, the carbonate precursor is not limited thereto, and examples thereof may include carbonyl bromide, bis haloformate, diphenyl carbonate, or dimethyl carbonate.

As the molecular weight modifier, a monofunctional material (monofunctional compound) similar to a monomer used to manufacture the polycarbonate resin, may be used. Non-limiting examples of the molecular weight modifier may include phenol as a basis and derivatives thereof (for example, para-isopropylphenol, para-tert-butylphenol, para-cumylphenol, para-isooctylphenol, or para-isononylphenol). In addition, various kinds of materials such as aliphatic alcohols may be used. Preferably, the molecular weight modifier may include para-tert-butylphenol (PTBP).

Examples of the aromatic polycarbonate resin manufactured using the dihydric phenol, the carbonate precursor, and the molecular weight modifier include a linear polycarbonate resin, a branched polycarbonate resin, a copolycarbonate resin, and a polyester carbonate resin.

The polycarbonate resin may have a viscosity average molecular weight (Mv) of about 15,000 to 40,000 or about 17,000 to 30,000 measured in a methylene chloride solution at 25° C. When the viscosity average molecular weight is less than about 15,000, mechanical properties such as impact strength and tensile strength may be deteriorated. When the viscosity average molecular weight is greater than about 40,000, melt viscosity may be increased, causing a problem in resin processing. In particular, in order to increase mechanical properties such as impact strength and tensile strength, the viscosity average molecular weight may suitaly be about 20,000 or greater. For processability, the viscosity average molecular weight may suitably be about 30,000 or less.

The antimicrobial composition may include an amount of about 45 to 85 wt % or an amount of about 50 to 75 wt % of the polycarbonate resin based on the total weight of the antimicrobial composition. When the content of the polycarbonate resin is within the above numerical range, heat resistance and impact resistance may be sufficiently expressed.

(b) Polyester Resin

The polyester resin may include an aromatic polyester resin, and may include a resin that undergoes polycondensation through melt polymerization from a terephthalic acid or terephthalic acid alkyl ester and a glycol component having 2 to 10 carbon atoms. The alkyl means an alkyl having 1 to 10 carbon atoms. Preferably, the aromatic polyester resin may suitably include a polyethylene terephthalate resin, a polytrimethylene terephthalate resin, a polybutylene terephthalate resin, a polyhexamethylene terephthalate resin, a polycyclohexane dimethylene terephthalate resin, or a polyester resin that is modified so as to have an amorphous property by mixing another monomer with the above resins. Preferably, a polyethylene terephthalate resin, a polytrimethylene terephthalate resin, a polybutylene terephthalate resin, or an amorphous polyethylene terephthalate resin may be used.

The intrinsic viscosity [η] of the polyester resin may be preferably about 0.85 to 1.52 dl/g, and or particularly of about 1.03 to 1.22 dl/g. When the polyester resin has an intrinsic viscosity [η] within the above range, excellent mechanical properties and moldability may be secured. Preferably, the polybutylene terephthalate may be preferably used.

The polybutylene terephthalate may include a condensation polymer obtained by direct esterification or transesterification of 1,4-butanediol and terephthalic acid or dimethyl terephthalate as monomers. Further, in order to increase the impact strength of the resin, the polybutylene terephthalate may be copolymerized with polytetramethylene glycol (PTMG), polyethylene glycol (PEG), polypropylene glycol (PPG), low molecular weight aliphatic polyester or aliphatic polyamide, or the polybutylene terephthalate may be used in the form of a modified polybutylene terephthalate blended with an impact enhancing component.

The antimicrobial composition may include an amount of about 10 to 36 wt % or of about 15 to 36 wt % of the polyester resin based on the total weight of the antimicrobial composition. When the contents of the polycarbonate resin and the polyester resin fall within the above numerical range, excellent impact resistance and heat resistance, which are the characteristics of the polycarbonate resin, may be expressed, and excellent chemical resistance may be secured.

(c) Inorganic Antimicrobial Agent

The inorganic antimicrobial agent may contain one or more antimicrobial materials selected from the group consisting of silver (Ag), zinc (Zn), copper (Cu), tin (Sn), platinum (Pt), barium (Ba), magnesium (Mg), germanium (Ge), and calcium (Ca). Preferably, the inorganic antimicrobial agent may include silver (Ag).

The antimicrobial material may be carried on a support. The support may include one or more selected from the group consisting of glass, zeolite, and zirconia.

The inorganic antimicrobial agent may contain the antimicrobial material in an amount of less than about 10 wt % based on the total weight of the antimicrobial composition. Even though the inorganic antimicrobial agent contains a very small amount of silver (Ag) which is an antimicrobial material, since the inorganic antimicrobial agent has a structure from which silver (Ag) ions are continuously released, a sufficient antimicrobial property may be secured.

The antimicrobial composition may contain the inorganic antimicrobial agent in a content of about 0.2 to 2 wt %, about 0.2 to 1.0 wt %, or about 0.4 to 0.8 wt %, based on the total weight of the antimicrobial composition. When the content of the inorganic antimicrobial agent is less than about 0.2 wt %, the antimicrobial property may not be sufficient, and when the content is greater than about 2 wt %, mechanical properties and thermal stability may be deteriorated.

The antimicrobial composition may have an average particle diameter (D50) of about 0.4 to 15 μm. When the average particle diameter (D50) of the antimicrobial composition is very large, physical properties and appearance quality may be deteriorated.

(d) Impact Modifier

The impact modifier may include a soft core containing a rubbery polymer and a hard shell containing a vinyl monomer graft-copolymerized to the core.

The core of the rubbery polymer manufactured by polymerizing one or more selected from the group consisting of C4-C6 diene-based rubber, acrylate-based rubber, and silicon-based rubber monomers may be graft-copolymerized with one or more monomers selected from among unsaturated compounds consisting of C1-C8 methacrylic acid alkyl esters, C1-C8 methacrylic acid esters, maleic anhydrides, and C1-C4 alkyl or phenyl nuclear-substituted maleimides, thus manufacturing the impact modifier.

The diene-based rubber may be a typical diene-based rubber that is usable in the present invention, for example, butadiene rubber, acryl rubber, ethylene/propylene rubber, styrene/butadiene rubber, acrylonitrile/butadiene rubber, isoprene rubber, or a ternary copolymer of ethylene-propylene-diene (EPDM), and is not limited so as to contain specific ingredients.

The acrylate-based rubber may be a typical acrylate-based rubber that is usable in the present invention, for example, acrylate monomers such as methyl acrylate, ethyl acrylate, n-propyl acrylate, n-butyl acrylate, 2-ethylhexyl acrylate, hexyl methacrylate, and 2-ethylhexyl methacrylate, and is not limited so as to contain specific ingredients. As a curing agent used in this case, ethylene glycol dimethacrylate, propylene glycol dimethacrylate, 1,3-butylene glycol dimethacrylate, 1,4-butylene glycol dimethacrylate, allyl methacrylate, or triallyl cyanurate may be used.

The silicon-based rubber may be manufactured from cyclosiloxane. Specific examples thereof may include hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrosiloxane, and octaphenylcyclotetrasiloxane, and the silicon-based rubber is not limited so as to contain specific ingredients. A curing agent used may suitably include trimethoxymethylsilane, triethoxyphenylsilane, tetramethoxysilane, or tetraethoxysilane.

Among the rubbers, the silicon rubber or a mixture of the silicon-based rubber and the acrylate-based rubber may be used to exhibit better effects in views of chemical resistance and thermal stability due to the structural stability thereof. The C1-C8 methacrylic acid alkyl esters or C1-C8 acrylic acid alkyl esters are esters of methacrylic acid or acrylic acid, and are esters manufactured from monohydryl alcohols having 1 to 8 carbon atoms. Preferably, the methacrylic acid alkyl esters may include methyl methacrylate ester, ethyl methacrylate ester, and propyl methacrylate ester, and the C1-C8 methacrylic acid alkyl esters or C1-C8 acrylic acid alkyl esters are not limited so as to contain specific ingredients, and may be preferably methyl methacrylate ester having excellent compatibility.

The antimicrobial composition may include the impact modifier in a content of about 3 to 12 wt % or about 4 to 10 wt %, based on the total weight of the antimicrobial composition. When the content of the impact modifier falls within the above numerical range, impact resistance, heat resistance, and chemical resistance may be increased in balance. When the content of the impact modifier is less than about 3 wt %, the impact strength may be deteriorated, and when the content is greater than about 12 wt %, gas may be generated to thus reduce the surface quality of the product.

(e) Micro Powder

The micro powder may contain a fluorine-based polymer resin.

The fluorine-based polymer resin may contain one or more selected from the group consisting of polytetrafluoroethylene, a tetrafluoroethylene-perfluoroalkyl vinyl ether copolymer, a tetrafluoroethylene-hexafluoropropylene copolymer, an ethylene-tetrafluoroethylene copolymer resin, a tetrafluoroethylene-chlorotrifluoroethylene copolymer, and an ethylene-chlorotrifluoroethylene resin. Preferably, the fluorine-based polymer resin may include preferably polytetrafluoroethylene.

The micro powder containing the fluorine-based polymer resin may be added to the antimicrobial composition to secure fingerprint resistance and further improve chemical resistance and antimicrobial and anti-fungal properties.

The micro powder may form a sphere.

The micro powder may have an average particle diameter (D50) of about 0.01 to 300 μm, about 0.1 to 40 μm, or about 0.1 to 20 μm. When the average particle diameter (D50) is less than about 0.01 μm, the effect of improving chemical resistance, fingerprint resistance, and antimicrobial and anti-fungal properties may be insufficient. When the average particle diameter is greater than about 300 μm, the dispersibility in polycarbonate is poor, which may adversely affect the appearance quality and physical properties of molded articles.

The weight average molecular weight (Mw) of the micro powder may be about 10,000 to 500,000 or about 50,000 to 300,000. When the weight average molecular weight (Mw) is less than about 10,000, the melting point may become about 300° C. or less, and thus the micro powder may be dispersed in the form of films during injection molding to cause peeling. When the weight average molecular weight is greater than about 500,000, fibrillation may occur due to external action such as shearing force during molding, resulting in poor processability and poor dispersibility in polycarbonate.

The antimicrobial composition may include the micro powder in a content of about 1 to 6 wt % or about 1.5 to 5 wt %, based on the total weight of the antimicrobial composition. When the content is less than about 1 wt %, the effect of improving fingerprint resistance and antimicrobial and anti-fungal properties may be insufficient. When the content is greater than about 6 wt %, fingerprint resistance and antimicrobial and anti-fungal properties are not increased any more, which may lead to deterioration in appearance quality and physical properties.

When the micro powder and the inorganic antimicrobial agent are used together as in the present invention, further improved antimicrobial and anti-fungal properties may be secured, and the amount of the inorganic antimicrobial agent that is used may be reduced.

(f) Additive

The antimicrobial composition may further include an additive such as a flame retardant, an antioxidant, a lubricant, a releasing agent, a nucleating agent, an antistatic agent, an ultraviolet (UV) stabilizer, a pigment, a dye, and a combination thereof, in addition to the above constitutional components, within the range not impairing the effect of the present invention.

When the additive is used, the content thereof may be 20 parts by weight or less, for example, about 0.1 to 10 parts by weight, based on 100 parts by weight of the antimicrobial composition, but is not limited thereto.

According to another aspect of the present invention, there is provided a molded article including the antimicrobial composition of the present invention described above. The molded article has excellent antimicrobial and anti-fungal properties, improved fingerprint resistance and chemical resistance, and high physical and chemical properties such as impact resistance and heat resistance. Further, the molded article satisfies an injection appearance property, which exhibits an excellent balance of physical properties. Therefore, the molded article may be widely used in electric and electronic, industrial material, and automobile interior part fields, and is particularly very suitable as a unpainted automobile interior material, but is not limited thereto.

The molded article according to an embodiment of the present invention is not particularly limited and may be manufactured using a method commonly known in the art. For example, the antimicrobial composition may be melt-extruded in an extruder to manufacture pellets, or the molded article may be manufactured using various processes such as injection molding, blow molding, extrusion molding, and hot molding.

### Example

A better understanding of the present invention may be obtained through the following Examples and Comparative Examples which are set forth to illustrate, but are not to be construed as the limit of the present invention.

### Examples and Comparative Examples

Components used in these Examples and Comparative Examples are specifically as follows.

(a) Polycarbonate

A polycarbonate thermoplastic resin (TRILOY 3030PJ, Samyang Corporation) having a viscosity average molecular weight (Mv) of 30,000 was used.

(b) Polyester

A polybutylene terephthalate resin (TRILOY 1700S, Samyang Corporation) having an intrinsic viscosity of 1.1 dl/g was used.

(c) Impact Modifier

A silicon-based rubber-modified graft copolymer having a core-shell structure was used, which was manufactured by graft-copolymerizing 70 wt % of a rubber having an average particle diameter of 110 nm and including dimethylsiloxane and butyl acrylate as a rubbery polymer (core) and 30 wt % of methyl methacrylate and methyl acrylate (methyl methacrylate/methyl acrylate (weight ratio)=99/1) as a shell component.

(d) Inorganic Antimicrobial Agent

A silver-zirconium-based antimicrobial agent (manufacturer: TOAGOSEI, product name: NOVARON AG1100) to which phosphate was added was used.

(e) Micro Powder

A polytetrafluoroethylene micro powder sphere (POLYFLONL-5F, DAIKIN Corporation) having an average particle size of 4.5 μm was used.

A polycarbonate resin, a polyester resin, an impact modifier, an inorganic antimicrobial agent, and a micro powder were prepared with the components and contents shown in Tables 1 and 2 below, mixed with each other using a Henschel mixer to be evenly dispersed, and extruded in a twin screw melt mixing extruder having L/D of 48 and Φ of 25 mm under conditions including a melting temperature of 260° C., a screw rotation speed of 300 rpm, a first vent pressure of about −600 mmHg, and a self-feeding rate of 30 kg/h. The extruded strand was cooled in water and then cut using a rotary cutter to manufacture pellets. The manufactured pellets were dried with hot air at 90 to 100° C. for 4 hours, and then injection-molded at a temperature of 250 to 270° C. to manufacture a specimen.

TABLE 1

| | Example | | | | | | | | | | | | |
|---|---|---|---|---|---|---|---|---|---|---|---|---|---|
| Composition (wt %) | 1 | 2 | 3 | 4 | 5 | 6 | 7 | 8 | 9 | 10 | 11 | 12 | 13 |
| (a) Polycarbonate | 71.8 | 71 | 72.4 | 69.4 | 74.4 | 67.4 | 81.4 | 61.4 | 70.6 | 69 | 72.8 | 65.6 | 71.4 |
| (b) Polyester resin | 20 | 20 | 20 | 20 | 20 | 20 | 10 | 30 | 20 | 20 | 20 | 25 | 20 |
| (c) Impact modifier | 6 | 6 | 6 | 6 | 3 | 10 | 6 | 6 | 6 | 6 | 6 | 8 | 6 |
| (d) Inorganic | 0.2 | 2.0 | 0.6 | 0.6 | 0.6 | 0.6 | 0.6 | 0.6 | 0.4 | 1.0 | 0.2 | 0.4 | 0.6 |
| antimicrobial agent | | | | | | | | | | | | | |
| (e) Micro powder | 2 | 2 | 1 | 5 | 2 | 2 | 2 | 2 | 3 | 4 | 1 | 1 | 2 |

TABLE 2

| | Comparative Example | | | | | | | | | |
|---|---|---|---|---|---|---|---|---|---|---|
| Composition (wt %) | 1 | 2 | 3 | 4 | 5 | 6 | 7 | 8 | 9 | 10 |
| (a) Polycarbonate | 71.9 | 70.5 | 72.9 | 65.4 | 86.4 | 51.4 | 76.4 | 62.4 | 73.8 | 85.6 |
| (b) Polyester resin | 20 | 20 | 20 | 20 | 5 | 40 | 20 | 20 | 20 | 10 |
| (c) Impact modifier | 6 | 6 | 6 | 6 | 6 | 6 | 1 | 15 | 6 | 4 |
| (d) Inorganic antimicrobial agent | 0.1 | 2.5 | 0.6 | 0.6 | 0.6 | 0.6 | 0.6 | 0.6 | 0.2 | 0.4 |
| (e) Micro powder | 2 | 2 | 0.5 | 8 | 2 | 2 | 2 | 2 | 0 | 0 |

Physical properties were measured for each of the specimens according to the Examples and Comparative Examples using the following method, and the results are shown in Tables 3 and 4.

(1) Antimicrobial Activity Value

In accordance with a JIS Z 2801 antimicrobial evaluation method, specimens having a size of 5 cm×5 cm were inoculated with Staphylococcus and Escherichia coli, and culturing was performed under a condition at a temperature of 35° C. and RH of 90% for 24 hours, followed by measurement. After culturing the bacteria for 24 hours thereon, the antimicrobial activity value was obtained according to the following [Equation 1] using the viable cell count (Ma) of the control after the culturing for 24 hours and the viable cell count (Mb) of the specimen after the culturing for 24 hours. The antimicrobial activity value of 3 or higher is judged to exhibit antimicrobial activity.

Antimicrobial activity value=log(Ma/Mb) [Equation 1]

(2) Anti-Fungal Property

Measurement was performed in accordance with an ASTM G-21 method. Examples of the strains that were used include Aspegillus niger ATCC 9642, Penicillium pinophilium ATCC 11797, Chaetomium globosum ATCC 6205, Gliocladium virens ATCC 9645, and Aureobasidium pullulans ATCC 15233. The degree of growth of the mold was evaluated after the test specimen was cultured for three weeks according to the grading criteria set as follows. The case of grade 0 is evaluated as having anti-fungal effect.

Grade 0: No mold growth and development.

Grade 1: Growth to 25% or less of the specimen area.

Grade 2: Growth to 26 to 50% of the specimen area.

Grade 3: Growth to 51 to 75% of the specimen area.

Grade 4: Growth beyond 75% of the specimen area.

(3) Fingerprint Resistance (Water Contact Angle/Sensory Evaluation)

[Water Contact Angle]

In order to confirm the degree of wetness of the liquid on the surface, the contact angle with respect to the surface of the specimen was measured. The contact angle of water was measured using phoenix-300 (SEO Corporation), and the amount of a solvent was 2 μl at room temperature. The contact angle is determined by the surface free energy, and the higher the contact angle, the lower the surface energy.

[Sensory Evaluation]

The thumb was pressed against the surface of the specimen for 10 seconds. In addition, after 5 minutes, the fingerprint was observed under a 3-wavelength fluorescent lamp (1000 lux), and the visibility of the fingerprint was evaluated according to the following criteria. It is judged that evaluation of 3 or higher is good.

5: Fingerprints are very hard to see

4: Fingerprints are difficult to see

3: Fingerprints are weakly visible

2: Fingerprints are visible

1: Fingerprints are very clearly visible

(4) Chemical Resistance Test

A band strip test (7 days) was conducted for the following fragrance combination solvent with tensile specimens based on ASTM D638 criteria. The evaluation intensity is 1 to 5, and the criteria are as follows.

Standard fragrance: Ratio of isoamylacetate:limonene:linalool of 2:0.5:0.5

(5) Heat Resistance (HDT)

The heat deflection temperature was measured under a condition including a load of 1.8 MPa and a heating rate of 120° C./hr for a specimen having a size of 80 mm×10 mm×4 mm according to ISO 75. The heat resistance is judged to be good at a temperature of 85° C. or greater.

(6) IZOD Impact Strength

The impact strength was measured according to ISO 180 for the injection specimens manufactured in the Examples and Comparative Examples.

TABLE 3

| | | Example | | | | | | | | | | | | |
|---|---|---|---|---|---|---|---|---|---|---|---|---|---|---|
| Physical properties | | 1 | 2 | 3 | 4 | 5 | 6 | 7 | 8 | 9 | 10 | 11 | 12 | 13 |
| (1) Antimicrobial | Escherichia | 3.6 | 6.4 | 5.9 | 6.6 | 6.1 | 5.8 | 6.0 | 5.7 | 5.0 | 6.8 | 3.1 | 4.1 | 6.0 |
| activity value | coli | | | | | | | | | | | | | |
| | Staphylococcus | 3.8 | 6.4 | 6.1 | 6.6 | 6.2 | 5.9 | 6.0 | 6.0 | 5.4 | 6.8 | 3.3 | 4.5 | 6.1 |
| (2) Anti-fungal | Anti-fungal | 0 | 0 | 0 | 0 | 0 | 0 | 0 | 0 | 0 | 0 | 0 | 0 | 0 |
| property | property | | | | | | | | | | | | | |
| (3) Fingerprint | Water contact | 10 | 10 | 10 | 11 | 10 | 10 | 10 | 10 | 11 | 11 | 10 | 10 | 10 |
| resistance | angle | 7 | 5 | 0 | 3 | 6 | 4 | 7 | 3 | 0 | 2 | 2 | 5 | 4 |
| | Sensory | 4 | 4 | 3 | 5 | 5 | 4 | 5 | 4 | 5 | 5 | 3 | 3 | 4 |
| | evaluation | | | | | | | | | | | | | |

| | | | | | | | | | | | | | |
|---|---|---|---|---|---|---|---|---|---|---|---|---|---|
| (4) Chemical resistance | 5 | 4 | 5 | 5 | 5 | 5 | 4 | 5 | 5 | 5 | 5 | 5 | 5 |
| (5) Heat resistance | 95 | 88 | 93 | 89 | 94 | 88 | 98 | 85 | 88 | 85 | 97 | 88 | 92 |
| (6) Impact strength | 58 | 51 | 57 | 50 | 50 | 64 | 59 | 51 | 53 | 50 | 60 | 58 | 55 |

TABLE 4

| | | Comparative Example | | | | | | | | | |
|---|---|---|---|---|---|---|---|---|---|---|---|
| Physical properties | | 1 | 2 | 3 | 4 | 5 | 6 | 7 | 8 | 9 | 10 |
| (1) Antimicrobial | Escherichia coli | 0.8 | 6.9 | 5.3 | 6.7 | 6.1 | 5.8 | 6.0 | 5.9 | 2.1 | 3.7 |
| activity value | Staphylococcus | 0.9 | 6.8 | 5.6 | 6.8 | 6.1 | 5.9 | 6.3 | 6.1 | 2.4 | 3.8 |
| (2) Anti-fungal | Anti-fungal | 3 | 0 | 0 | 0 | 0 | 0 | 0 | 0 | 2 | 0 |
| property | property | | | | | | | | | | |
| (3) Fingerprint | Water contact | 105 | 103 | 94 | 115 | 107 | 102 | 105 | 106 | 91 | 90 |
| resistance | angle | | | | | | | | | | |
| | Sensory | 4 | 4 | 2 | 5 | 4 | 4 | 5 | 4 | 2 | 2 |
| | evaluation | | | | | | | | | | |

| | | | | | | | | | | |
|---|---|---|---|---|---|---|---|---|---|---|
| (4) Chemical resistance | 5 | 3 | 5 | 5 | 2 | 5 | 4 | 5 | 5 | 2 |
| (5) Heat resistance | 94 | 82 | 94 | 82 | 99 | 78 | 97 | 80 | 98 | 103 |
| (6) Impact strength | 57 | 46 | 59 | 42 | 61 | 47 | 23 | 68 | 62 | 58 |

The resin composition in the Example of the present invention showed an excellent balance of all measured properties. In the case of antimicrobial and anti-fungal tests, the antimicrobial activity value showed the antimicrobial activity of 3 or greater and the anti-fungal effect of 0 grade for all compositions. In the case of the fingerprint resistance test, the grade was 4, showing that fingerprints are difficult to see, which means excellent fingerprint resistance.

Further, excellent properties are secured in views of chemical resistance, heat resistance, and impact resistance. In contrast, in the case of the compositions of the Comparative Examples, antimicrobial and anti-fungal properties, fingerprint resistance, chemical resistance, heat resistance, and IZOD impact strength showed unbalanced characteristics compared to the case of the Examples, which may significantly reduce various properties of the final product. In addition, excellent antimicrobial and anti-fungal properties are secured in the case of 0.6 wt % of the antimicrobial agent, but in the case of 0.2 wt % of the antimicrobial agent, antimicrobial and anti-fungal properties are secured only in the test to which the fluorine-based polymer is applied, which shows that there is a synergistic effect between the antimicrobial agent and the fluorine-based polymer. Accordingly, the antimicrobial and anti-fungal properties may be secured with a minimal content of the antimicrobial agent, thus obtaining the effect of preventing a reduction in physical properties such as heat resistance and impact resistance.

As can be seen from this, when a molded article is manufactured using the polycarbonate/polyester alloy resin composition of the present invention, it is possible to maintain excellent heat resistance, impact resistance, and chemical resistance, and also secure excellent antimicrobial and anti-fungal properties and fingerprint resistance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An antimicrobial composition comprising:
a polycarbonate resin;
a polyester resin;
an inorganic antimicrobial agent;
an impact modifier; and
a micro powder including a fluorine-based polymer resin.

2. The antimicrobial composition of claim 1, the antimicrobial composition comprising:
an amount of about 45 to 85 wt % of the polycarbonate resin;
an amount of about 10 to 36 wt % of the polyester resin;
an amount of about 0.2 to 2 wt % of the inorganic antimicrobial agent;
an amount of about 3 to 12 wt % of the impact modifier; and
an amount of about 1 to 6 wt % of the micro powder,
all the wt % is based on the total weight of the antimicrobial composition.

3. The antimicrobial composition of claim 1, wherein the polycarbonate resin comprises an aromatic polycarbonate resin.

4. The antimicrobial composition of claim 1, wherein the polycarbonate resin has a viscosity average molecular weight (Mv) of about 15,000 to 40,000 measured in a methylene chloride solution at a temperature of about 25° C.

5. The antimicrobial composition of claim 1, wherein the polyester resin comprises one or more selected from the group consisting of a polyethylene terephthalate resin, a polytrimethylene terephthalate resin, a polybutylene terephthalate resin, a polyhexamethylene terephthalate resin, a polycyclohexane dimethylene terephthalate resin, and an amorphous modified substance thereof.

6. The antimicrobial composition of claim 1, wherein the polyester resin has an intrinsic viscosity [η] of about 0.85 to 1.52 dl/g.

7. The antimicrobial composition of claim 1, wherein the inorganic antimicrobial agent comprises one or more antimicrobial materials selected from the group consisting of silver (Ag), zinc (Zn), copper (Cu), tin (Sn), platinum (Pt), barium (Ba), magnesium (Mg), germanium (Ge), and calcium (Ca) and a support containing the antimicrobial material.

8. The antimicrobial composition of claim 7, wherein the support comprises one or more selected from the group consisting of glass, zeolite, and zirconia.

9. The antimicrobial composition of claim 1, wherein the impact modifier comprises a core comprising a rubbery polymer, and a shell comprising a vinyl monomer graft-copolymerized to the core.

10. The antimicrobial composition of claim 1, wherein the micro powder comprises one or more fluorine-based polymer resins selected from the group consisting of polytetrafluoroethylene, a tetrafluoroethylene-perfluoroalkylvinyl ether copolymer, a tetrafluoroethylene-hexafluoropropylene copolymer, an ethylene-tetrafluoroethylene copolymer resin, a tetrafluoroethylene-chlorotrifluoroethylene copolymer, and an ethylene-chlorotrifluoroethylene resin.

11. The antimicrobial composition of claim 1, wherein the micro powder forms a sphere.

12. The antimicrobial composition of claim 1, wherein the micro powder has an average particle diameter (D50) of about 0.01 to 300 μm.

13. The antimicrobial composition of claim 1, wherein the micro powder has a weight average molecular weight (Mw) of about 10,000 to 500,000.

14. A molded article comprising:
an antimicrobial composition of claim 1.
